(19) United States
(12) Patent Application Publication
(10) Pub. No.: US 2004/0242272 A1
(43) Pub. Date: Dec. 2, 2004

(54) Antenna system for adjustable sectorization of a wireless cell

(76) Inventors: Richard T. Aiken, Convent Station, NJ (US); Roger D. Benning, Long Valley, NJ (US)

Correspondence Address: Greenberg Traurig, LLP, 885 Third Avenue, New York, NY, 10022, US

(21) Appl. No.: 10/448,481

(22) Filed: May 29, 2003

(51) Int. Cl. H01Q 3/24; H04B 1/38

(52) U.S. Cl. 455/562.1; 455/561; 342/368

(57) ABSTRACT

A system and method for routing antenna beams from a multibeam antenna array to another sector to increase cell capacity in cells having nonuniform mobile user density. The antenna arrays radiate beams of alternating orthogonal polarizations so that adjacent beams do not destructively interfere with each other. One or more individual beams radiated by an antenna array serving an overloaded sector of a cell of a wireless communication system can be made to serve another sector of the cell having a relatively light load by re-routing the signals associated with said one or more individual beams.

### BACKGROUND OF THE INVENTION

1. Field of the Invention

The present invention relates to antenna systems for wireless communication systems.

2. Description of the Related Art

Wireless communication systems allow users to communicate with each other over one or more defined geographic areas called cells. Each cell has one or more sets of base station equipment that transmit and receive communication signals to and from users located in that cell. The sets of base station equipment also communicate with each other. The user signals are transmitted to mobile users and received by the base station equipment with the use of antennas. The cells are often divided into sectors where each sector is served by a particular antenna, i.e., a sector antenna. A particular antenna assigned to a sector of a cell transmits signals that have a beam pattern that covers the region defined by the sector. The beams transmitted by each antenna of a sector often are communication signals that have the same characteristics such as amplitude, frequency and phase values. Signals from adjacent antennas can be polarized orthogonally so that they don't interfere with each other.

Each antenna transmits signals for a specific number of communication channels allocated to that antenna. Thus, the entire cell has a user capacity related to the total number of communication channels that can be supported by the sector equipment and antennas of that cell. As users migrate from sector to sector within a cell or from one sector of one cell to a sector of another cell, it is desirable for the communication system to have the resources throughout the different cells to adequately serve the users of the system. However, the migration of users often causes overload conditions in certain sectors. An overload condition occurs when a sector cannot serve a user because of mutual interference among the communication signals, thermal noise in the radio electrical components or the sector does not have the resources to serve that user. The resources may be in the form of communication channels, power and/or bandwidth.

When a sector reaches its capacity, users of the system currently located in that sector who want to use the system are unable to enter the system. Further, sometimes users currently using the system may be removed from service (e.g., telephone calls are dropped) when the sector has reached its capacity. While a sector is fast approaching or has reached its capacity, often neighboring sectors within the same cell or in a different cell are operating at relatively low capacity. As a result, communication systems can be designed so that their antenna systems allow them to transfer users to neighboring sectors when the need arises. However, even though a neighboring sector may have the requisite capacity to serve these users, the antenna beam pattern may not be wide enough to cover the transferred group of users or mobiles; hereinafter, the terms ‘users’ and ‘mobiles’ will be used interchangeably. To address this problem some wireless communication systems use fixed antennas of various beam widths. A beam width is typically measured and expressed in term of degrees.

FIG. 1 shows a top view of a typical beam created by a transmitting antenna. There is a point on the beam where the peak transmission power level occurs which is labeled PEAK and the points where the power is 50% of peak are labeled HALF POWER POINT. The lines constructed from the HALF POWER POINTS to the origin point of the beam form an angle that is used to define the width of the beam. The beam width shown in FIG. 1 is thus 30°. A system having fixed antennas of various beam widths is able to transfer load from one antenna to another as circumstances require. Further such systems have narrow beam width antennas pointed in certain directions where the density of user population is typically relatively high. The problem with this approach is that it requires antennas specifically designed for a particular site and such antennas require site-specific engineering and configuration.

Another approach is to use an antenna structure that has many beams. For example an antenna system having twelve (12) 30° beams can be used where sets of beams are assigned to certain sectors. For example, two 30° beams would serve a 60° sector in the direction in which traffic is relatively high. Five beams would serve each of two remaining sectors of 150°. Such an antenna structure can be made with an antenna array comprising four columns of vertically polarized antenna elements coupled to a four-port Butler feed as shown in FIG. 2. Generally, an antenna array is a structure having two or more antennas or antenna elements. A Butler feed is a passive network having one or more inputs and two or more outputs (commonly referred to as ports) whereby the application of a signal to one input port results in an output signal from all of the output ports of the network where specific phase and amplitude relationships among the output signals can be designed based on the configuration of the internal circuitry of the Butler feed. In FIG. 2, the output signals at all four ports activate the four columns of the antenna array which generates field signals that combine and/or interact with each other to form a beam. In a downlink transmission (i.e., transmission from base station to mobiles) the Butler feed is designed such that driving one port of the feed activates all four columns of the array so that one 30° beam is formed in a particular direction associated with that port. Moreover, driving each port results in a beam separated by 30° from the beam formed when driving an adjacent port. Similar beams are formed for uplink receptions (i.e., transmissions from mobiles to base station). The approach represented by FIG. 2 permits the use of a generic rather than a site specific set of antennas. This approach also permits adjustment of the sectors by system reconfiguration on the ground, i.e., reassignment of beams to sectors, rather than requiring mechanical adjustment of antennas on the tower in order to shift traffic load from a high traffic sector to low traffic sectors.

A system from a company called Metawave (hereinafter “the Metawave system”) uses the approach of antenna usage represented in FIG. 2. The Metawave system uses vertically polarized antennas as shown in FIG. 2. When signals are applied to the input ports of the Butler feed, beams of signals are generated from the antenna array. A signal applied to input port 1, for example, activates all four columns of vertically polarized antenna elements forming an antenna beam of a certain beam width. The beam width depends on the design of the antenna array, and in particular, how the resultant signals from each of the four columns interact with each other to form the beam. For the antenna array shown in FIG. 2, an application of signals to each of the input ports results in four beams that overlap each other somewhat. In the overlap region of two adjacent beams, there may be destructive or constructive interference. Because all of the antenna elements are vertically polarized, adjacent beams may interfere destructively and thus a mobile located in an area of destructive interference would not receive an adequate signal from the antenna array. The destructive interference originates from beams becoming out of phase with each other thus interfering destructively with each other. Because of differences in links of cables and phase differences among various electrical components in the system, the phase of each beam is not easily controllable. Even more difficult is the control of the phase of one beam with respect to the phase of an adjacent beam to prevent destructive interference. To mitigate the destructive interference, especially between adjacent beams, the input signals in the Metawave system to the Butler feed are delayed with respect to each other by a certain time period resulting in multipath signals to the mobile. However, these multipath signals introduce some degradation in the mobile receiver of such signals. Some mobile receivers designed to receive and process multi path signals are called RAKE receivers that contain multiple fingers for the reception of signals having different paths. But RAKE receivers have a limited number of fingers designed to process multipath signals that occur naturally from the demographics of a communication link. Therefore, a multipath signal purposely generated by the addition of delay between the beams will use a finger and tend to reduce a mobile's ability to properly receive and process signals within the communication system.

What is therefore needed is an antenna system that is able to transfer users to different sectors of a cell of a wireless communication system based on differing sector capacities without having to resort to site-specific engineered antenna systems and without having to generate multi path signals.

### SUMMARY OF THE INVENTION

The present invention provides a system and method for generating a plurality of beams of signals of alternating slant polarizations in a wireless communication system. More particularly, the present invention enables the beams of signals to be arranged into subsets of beams in which each of the subsets is transmitted through a communication channel or radio of the wireless communication system. One system of the present invention supports re-routing signals that generate certain beams to certain radios and/or communication channels to meet changing capacity demands of the communication system. One or more beams of a subset of beams associated with a first communication channel or radio approaching the capacity in its sector (or having reached its capacity) can, by re-routing signals generating the one or more beams, now be associated with a second communication channel or radio so as to transfer some of the capacity of the first communication channel or radio to the sector served by the second communication channel or radio. The decision to re-route a signal associated with a beam and to what channel or radio such beam is to be re-routed is based on any one of a number or algorithms designed to prevent overload conditions in the geographical areas covered by the wireless communication system.

One method of the present invention first generates one or more sets of beams of alternating slant polarizations. Each set of beams covers a specific geographic area or sector of a certain size and is serviced through a specific communication channel by a particular radio. Because adjacent beams have orthogonal polarization, in the overlap region there is no destructive or constructive interference. Thus a mobile located in an area of beam overlap will tend to receive an adequate signal prior to handoff.

The capacity of the communication channels or radios covering certain geographic areas is monitored and when a geographic area or sector serviced by a radio or channel is approaching its capacity or has reached its capacity one or more of its beams are re-routed through another channel or radio allowing such other sector to handle some of the capacity of the overloaded sector. The beams are re-routed by re-routing the signals associated with or the signals generating such beams. In the method described, the geographic areas or sectors are altered so as to equalize the number of mobiles they service thereby allowing the capacity of the system to approach its theoretical capacity.

### BRIEF DESCRIPTION OF THE DRAWINGS

FIG. 1 is a top view of a typical beam pattern radiated by an antenna;

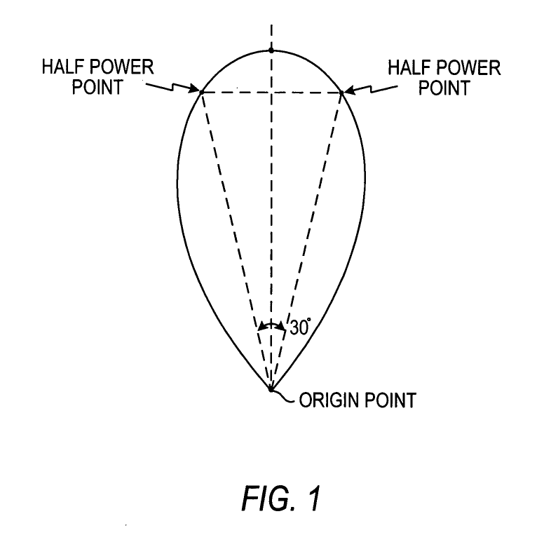

FIG. 2 shows an antenna array of vertically polarized antenna elements coupled to a Butler feed;

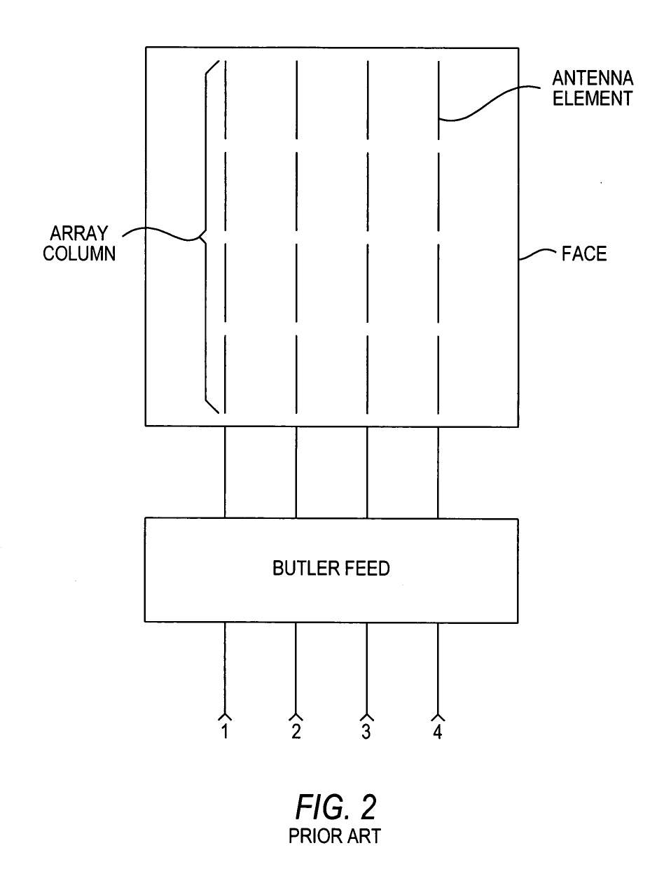

FIG. 3 is a diagram of the system of the present invention;

FIG. 4 shows the resulting beam pattern generated by the system of FIG. 3 when located in a cell of a wireless communication system.

FIG. 5 shows the resulting beam pattern generated by the system of FIG. 3 when one beam is re-routed from one sector to another sector.

### DETAILED DESCRIPTION

The present invention provides a system and method for generating a plurality of beams of signals of alternating slant polarizations in a wireless communication system. More particularly, the present invention enables the beams of signals to be arranged into subsets of beams in which each of the subsets is transmitted through a particular communication channel or radio of the wireless communication system. One system of the present invention supports re-routing signals that generate certain beams to certain radios and/or communication channels to meet changing capacity demands of the communication system. One or more beams of a subset of beams associated with a first communication channel or radio approaching the capacity in its sector (or having reached its capacity) can, by re-routing signals generating the one or more beams, now be associated with a second communication channel or radio so as to transfer some of the capacity of the first communication channel or radio to the second communication channel or radio. The decision to re-route a signal associated with a beam and to what channel or radio such signal is to be re-routed is based on any one of a number or algorithms designed to prevent overload conditions in the geographical areas covered by the wireless communication system.

One method of the present invention first generates one or more sets beams of alternating slant polarizations. Each set of beams covers a specific geographic area or sector of a certain size and is serviced through a specific communication channel by a particular radio. Because adjacent beams have orthogonal polarization, in the overlap region there is no destructive or constructive interference. Thus a mobile located in an area of beam overlap will tend to receive an adequate signal prior to handoff.

The capacity of the communication channels or radios covering certain geographic areas is monitored and when a geographic area or sector serviced by a radio or channel is approaching its capacity or has reached its capacity one or more of its beams are re-routed to another channel or radio allowing such other radio or channel to handle some of the capacity of the overloaded sector. The beams are re-routed by re-routing the signals associated with or the signals generating such beams. In the method described, the geographic areas or sectors are altered so as to equalize the number of mobiles they service thereby allowing the capacity of the system to approach its theoretical capacity.

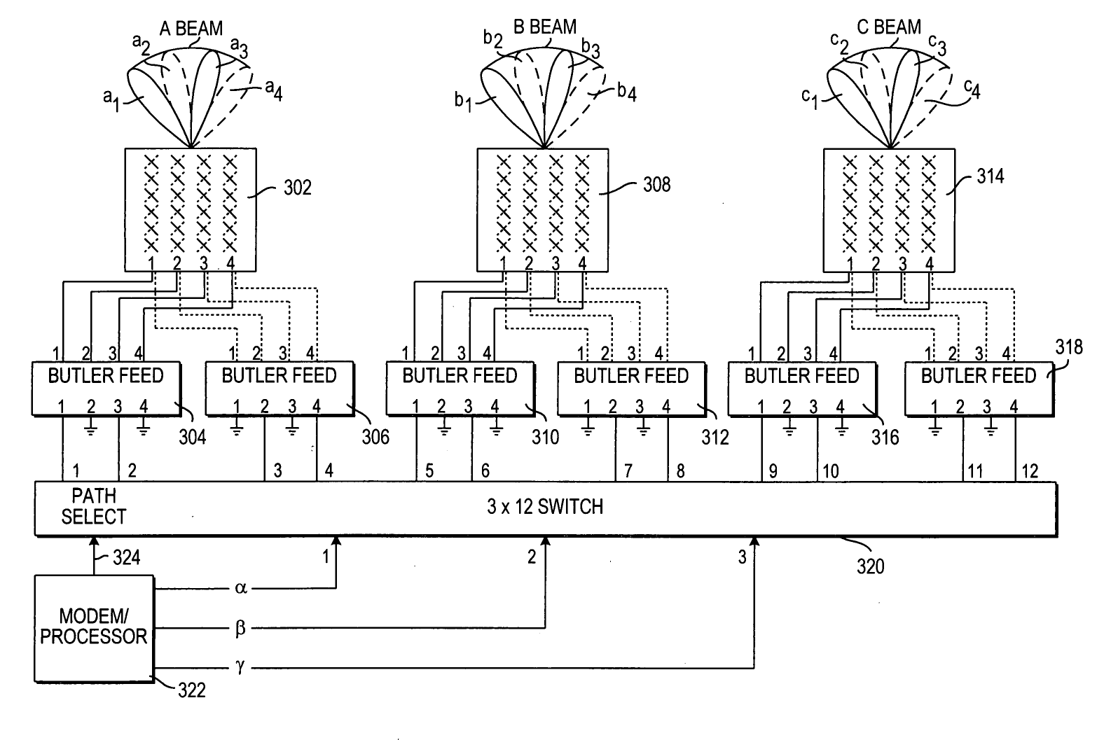

Referring to FIG. 3 there is shown the system of the present invention comprising three antenna arrays each of which is coupled to two Butler feeds and the Butler feeds are coupled to a 3×12 switch (3 inputs and 12 outputs). The 3×12 switch has three inputs where each input is coupled to a communication channel or radio. The system of the present invention is placed in a cell divided into three 120° sectors. Antenna array 302 generates an aggregate beam, A, which is the combination of individual beams a₁, a₂, a₃ and a₄. Antenna array 308 generates aggregate beam, B, which is the combination of individual beams b₁, b₂, b₃ and b₄. Antenna array 314 generates an aggregate beam, C, which is the combination of individual beams c₁, c₂, C₃ and C₄. Each of the antenna arrays contains four columns of left slant polarized antenna elements (i.e., solid line antennas) co-located with four columns of right slanted antennas (i.e., dashed line antennas). The antenna elements can be dipole antennas, patch antennas or any other well-known antenna type. The left slant and right slant polarizations are preferably ±45° respectively. Therefore adjacent beams have a difference in polarization of 90° and as such are orthogonal to each other. Each of the four columns has six of each set of polarized antennas. Further, each antenna array has eight inputs (two inputs per column) which allow one to activate either the left slant or right slant antenna columns or both co-located columns.

FIG. 3 shows three different communication channels or signals from modem/processor 322 applied to inputs 1, 2 and 3 of 3×12 switch 320. Switch 320 is controllable via path 324 to route any of its three (3) inputs to any one or more of its 12 outputs. Switch 320 is any switch that can be controlled by analog or digital signals and which routes signals from any of its inputs to any of its outputs. A control signal generated by modem/processor 322 onto path 324 causes switch 320 to route communication signals from channel or radio α (not shown) to outputs 1-4 of switch. Communication signals from radio or channel β (not shown) are routed to outputs 5-8 of switch 320. Communication signals from radio or channel γ (not shown) are routed to outputs 9-12 of switch 320. It should be noted that the realization shown in FIG. 3 is one particular use of the system of the present invention. In general, the purpose of the system of the present invention is to make any of the radios or channels available to any of the sectors; that is, any of the radios (α, β or γ) can be assigned to any of the ports 1-12.

Referring now to antenna array 302, the left slanted antennas are being activated by 4×4 Butler feed 304 (i.e., 4 inputs and 4 outputs) and the right slanted antennas are being fed by 4×4 Butler feed 306. Inputs 2 and 4 of Butler feed 304 and inputs 1 and 3 of Butler feed 306 are not used. Input 1 of Butler feed 304 drives all four left slanted columns of antenna array 302 forming individual beam a₁. Input 3 of Butler feed 304 drives all four left slanted columns of antenna array 302 forming individual beam a₃. Input 2 of Butler feed 306 drives all four right slanted columns of antenna array 302 to form individual beam a₂. Input 4 of Butler feed 306 also drives all four right slanted columns forming individual beam a₄. Each of the individual beams has a beamwidth of 30°. Note that as a result of the particular usage of the Butler feeds (304, 306) the resulting individual beams have alternating slant polarizations. In particular, a₁ beam has a left slant polarization (i.e., −45°), a₂ has a right slant polarization (i.e., +45°), a₃ has a left slant polarization and a₄ beam has a right slant polarization. Although beams a₁ and a₃ have the same polarizations, there is substantially no interference between these two beams because they are separated by 60°. Similarly, beams a₂ and a₄ have the same polarizations but do not substantially interfere with each other as they are separated by 60°. Adjacent beams do not interfere with each other because of their orthogonal polarizations.

Antenna array 308 coupled to Butler feeds 310 and 312 and antenna array 314 coupled to Butler feeds 316 and 318 operate in substantially the same manner as antenna array 302. In particular, antenna array 308 and 310 each generates four individual antenna beams of alternating slant polarizations; each of the individual antenna beams has a beam width of 30°. Beams b₁, b₃, C₁ and C₃ have left slant polarizations and beams and b₂, b₄, c₂ and C₄ have right slant polarizations.

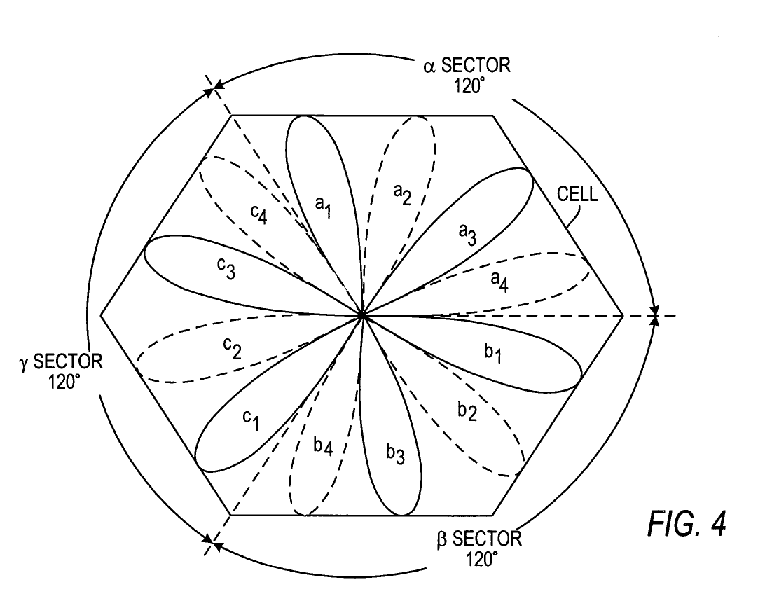

When the antenna system of FIG. 3 is operating in a cell that is sub-divided into 3 120° sectors, the resulting alternating slant polarizations of the individual beams is shown in FIG. 4. The beams shown in dashed lines are right slant polarized beams and the beams shown in solid lines are left slant polarized beams; thus FIG. 4 shows the beams arranged in alternating slant polarizations. It should be noted that the communication signals that form or generate the different beams may have the same characteristics or different characteristics. The characteristics of the signals comprise signal frequency, amplitude and/or power level. For example, the communication signals may be signals of a CDMA (Code Division Multiple Access) wireless communication system. Each of the three radios or communication channels (α, β and γ) covers a 120° sector of a cell of a wireless communication system. At some point, one of the three sectors may be approaching its capacity. Many wireless communication systems designate a certain capacity for their communication channels or radios. The capacity can be defined in terms of such resources as transmission power, allocated bandwidth or user codes. Each cell has processing equipment (not shown) that is part of the base station equipment or is coupled to the base station equipment where such processing equipment monitor the amount of resources being used by the sectors to determine when a particular sector is approaching its capacity. The communication system can use any feasible algorithm to determine when a sector is approaching its capacity. For example, each sector may be allocated a certain amount of total transmission power. When the transmission power of a sector is 90% of its allocated total power for a certain time period, that sector may be deemed to be approaching its capacity. A sector that is approaching its capacity or has reached its capacity is in an overload condition.

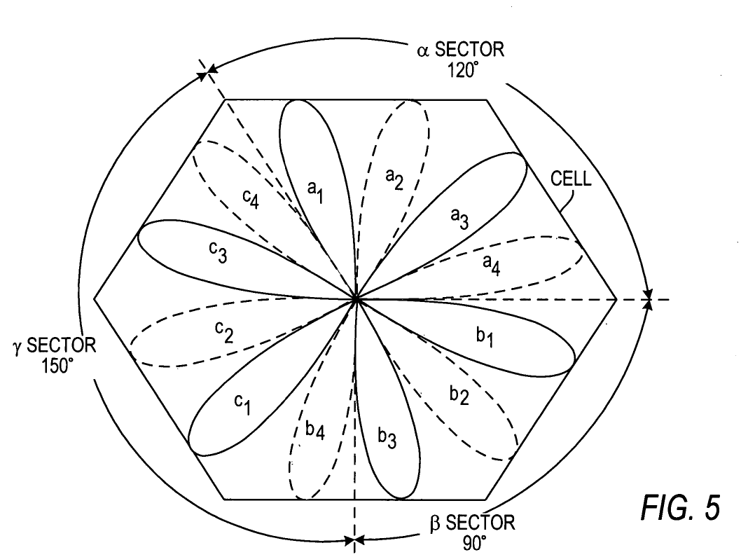

The system and method of the present invention can determine if any of the adjacent sectors can handle additional users transferred from the overloaded sector. The system and method of the present invention knows whether each of the other sectors is in an overload condition (or is approaching an overload condition) because the capacity of each such sector is being monitored by the system and method of the present invention. A beam is formed by one or more signals applied to an input of a Butler feed coupled to an antenna array. The signals that create or generate the different beams can be re-routed by the method and system of the present invention so that a beam formerly belonging to one sector is now being routed from or through a radio or communication channel of another sector. For example, suppose the β sector has been deemed to be approaching its capacity and suppose further that the γ sector has a relatively low mobile density (i.e., relatively light load), the method of the present invention can re-route the signals for an individual beam serving the β sector so that this beam becomes part of the γ sector is now being radiated through the γ radio or communication channel. Thus, to offload users from the β sector to the γ sector, the user signals are combined with the user signals for the γ sector and then fed to Butler feed 312 or 310 (depending on which beam is affected); this has the effect of increasing the area coverage of the γ sector while decreasing the area coverage of the β sector. As a result the aggregate beam for the β sector now comprises three (3) 30° beams and the γ sector now comprises five (5) 30° beams as depicted in FIG. 5. The γ channel or radio is now able to handle some users originally in the β sector with the addition of the b₄ individual beam. Referring to FIG. 3, the signal that creates b₄ is re-routed through switch 320 so that it is applied to one of the inputs of Butler feed 312. A control signal on path 324 is generated by modem/processor 322 to cause the b₄ signals to be re-routed to the γ sector as shown in FIG. 5. Butler feed 312 is used because the method and system of the present invention wants to maintain the polarization of the transferred beam. In particular in order for beam b₄ to maintain its right slant polarization it is routed to a Butler feed that activates the right slant antenna elements; in this manner the alternating slant polarization beam pattern of the cell is maintained. It is still the case that because adjacent beams have orthogonal polarization, there is no destructive or constructive interference in the overlap region. Thus a mobile located in an area of beam overlap will still receive an adequate signal. Preferably the beam that is transferred is one that is contiguous to the new sector. In other words, beam b₄ is transferred to the γ sector because of that beam's location with respect to the γ sector. In general, however, any of the B beams could have been transferred to the γ sector.

The system and method of the present invention also operates as a receiver. In the receive mode, the antenna arrays receive one or more signals. Usually two signals are received per sector to obtain diversity to combat fading (i.e., attenuation) of the signals as they propagate through the air. One technique would be to form one receive signal from the sum of left-slant polarized beams and a second signal from the sum of right-slant polarized beams. Other combinations of different polarized beams are, of course, possible.

We claim:

1. An antenna system for a wireless communication system, the antenna system comprising:
at least one antenna array;
a switch coupled to the at least one antenna array for routing signals applied to the switch which signals are to any input of the at least one array to generate signal beams of alternating polarizations.

2. The antenna system of claim 1 where the alternating polarizations are orthogonal slant polarizations at −45° and +45°.

3. The antenna system of claim 1 where the signals are routed to the at least one antenna array via at least one Butler feed.

4. The antenna system of claim 1 where a control signal generated by the communication system causes the switch to re-route a signal such that at least one of a plurality of beams generated by the signal and where the at least one of a plurality of beams formerly radiated through a radio serving one sector is now radiated through a radio of another sector.

5. The antenna system of claim 4 where the signal is re-routed from an overloaded sector of a cell of the wireless communication system to another sector of the cell.

6. The antenna system of claim 1 where the at least one antenna array comprises three four-column antenna arrays where each column has a plurality of 45° slant polarized antenna elements and −45° polarized antenna elements and the switch is a 3-input, 12-output switch whose outputs are coupled to six 4×4 Butler feeds and each antenna array is coupled to a pair of Butler feeds.

7. A method for transmitting signal beams, the method comprising the step of:
re-routing a beam from a first sector to a second sector where the beams have alternating slant polarizations.

8. The method of claim 7 where the first antenna array serving an overloaded sector of a cell and the second antenna array is serving a sector of the cell of relatively light load.

9. The method of claim 7 where the step of re-routing a signal further comprises:
monitoring each sector of a cell of a communication system within which the antenna arrays are located; and
determining whether a sector is in an overload condition or is approaching an overload condition.
